(19) United States
(12) Patent Application Publication
(10) Pub. No.: US 2008/0309207 A1
(43) Pub. Date: Dec. 18, 2008

(54) Composite refrigerated exhibition group and an improved joining assembly for refrigerated exhibition counters

(75) Inventor: Filippo Marzaro, Reschigliano Di Campodarsego (IT)

Correspondence Address: HEDMAN & COSTIGAN P.C., 1185 AVENUE OF THE AMERICAS, NEW YORK, NY, 10036, US

(73) Assignee: ARNEG S.p.A, Loc. Marsango Campo San Martino (IT)

(21) Appl. No.: 12/156,982

(22) Filed: Jun. 6, 2008

(30) Foreign Application Priority Data
Jun. 18, 2007 (IT) MI2007A 001216

(51) Int. Cl. F16B 12/00; A47F 3/04

(52) U.S. Cl. 312/111; 312/116

(57) ABSTRACT

A composite refrigerated exhibition group (100) comprising at least a first and a second refrigerated exhibition counter (11, 12) and a coupling element (10) interposed between them (11, 12), wherein at least one between first and second refrigerated exhibition counter (11, 12) is connected at a variable angular position with respect to the coupling element (10). In a further embodiment, the group provides for a constraint between at least one of the first or second refrigerated exhibition counter (11, 12) and the coupling element (10) and the positioning of the other counter according to a desired angular position to provide the required conformation.

The present invention refers to composite refrigerated exhibition group and an improved assembly of coupling elements for refrigerated exhibition counters.

Currently, in particular exhibition devices, provided with refrigerating systems, which are used to exhibition and preserve special types of products are widely spread.

In particular, such refrigerating exhibition devices are often used in supermarkets, canteens etc, to offer the possibility to purchase fresh products and keep such goods in an environment with a suitable temperature.

Referring to the use of such refrigerated exhibition devices, there subsequently arose the problem regarding the optimisation of spaces for positioning the same.

Nowadays, in order to meet the most varied requirements, available in the market are refrigerating exhibition devices of various dimensions. Furthermore, alongside such diversification available in the market are also composite refrigerated exhibition groups deriving from the assembly of independent exhibition sub-modules.

Thus, in this manner, it is currently possible to provide composite refrigerated exhibition groups of various dimensions exploiting their modularity and hence optimising the exhibition spaces available from time to time.

Still with the objective of optimising the exhibition spaces, currently available are special joining assemblies for refrigerated exhibition counters which allow providing angular exhibition groups also, that is groups whose profile is not solely rectilinear.

However, disadvantageously, such angular joining assemblies known for refrigerated exhibition counters allow obtaining only preset and fixed “angles”, for example 90°, thus allowing to attain from time to time an angular exhibition group with a fixed angle and unsuitable to adapt to various requirements.

Thus, today it is not possible to use a single angular joining assembly to characterise the same group of refrigerated counters according to more than one preset angle.

The objective of the present invention is that of providing a device capable of overcoming the abovementioned drawbacks of the known art in an extremely simple, inexpensive and particularly functional manner.

Another objective is that of providing a composite refrigerated exhibition group capable of being positioned angularly according to any angular configuration required without replacing any of the components.

Still, another objective of the present invention is that of being provided with an improved joining assembly capable of being associated to the refrigerated exhibition counters and capable of allowing to form using the latter a composite refrigerated exhibition group which can be positioned angularly according to any angular configuration required.

These objectives according to the present invention are attained by providing a composite refrigerated exhibition group and an improved joining assembly for refrigerated exhibition counters as described in claims 1 and 9.

Further characteristics of the invention shall be outlined by the subsequent claims.

Characteristics and advantages of a composite refrigerated exhibition group and an improved joining assembly for refrigerated exhibition counters according to the present invention shall be more evident from the following exemplifying and non-limiting description with reference to the attached schematic drawings wherein:

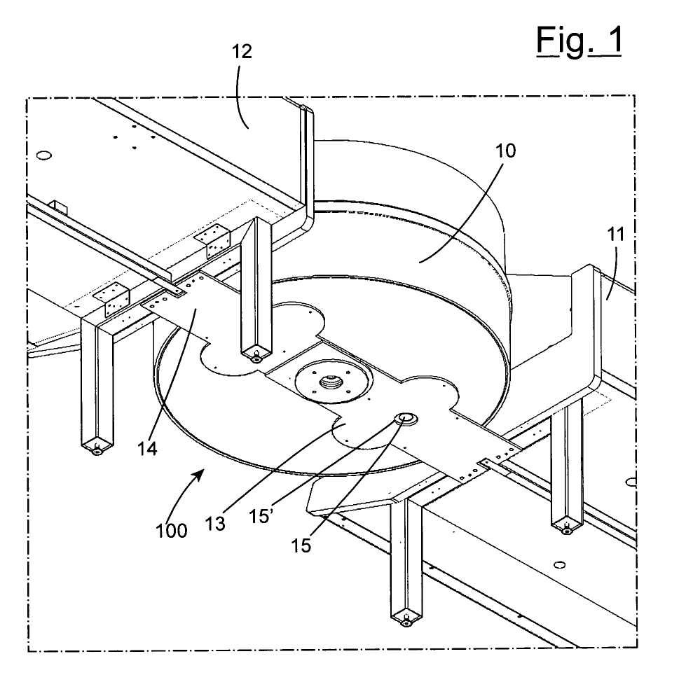

FIG. 1 is a schematic perspective bottom view of an embodiment of a composite refrigerated exhibition group according to the invention;

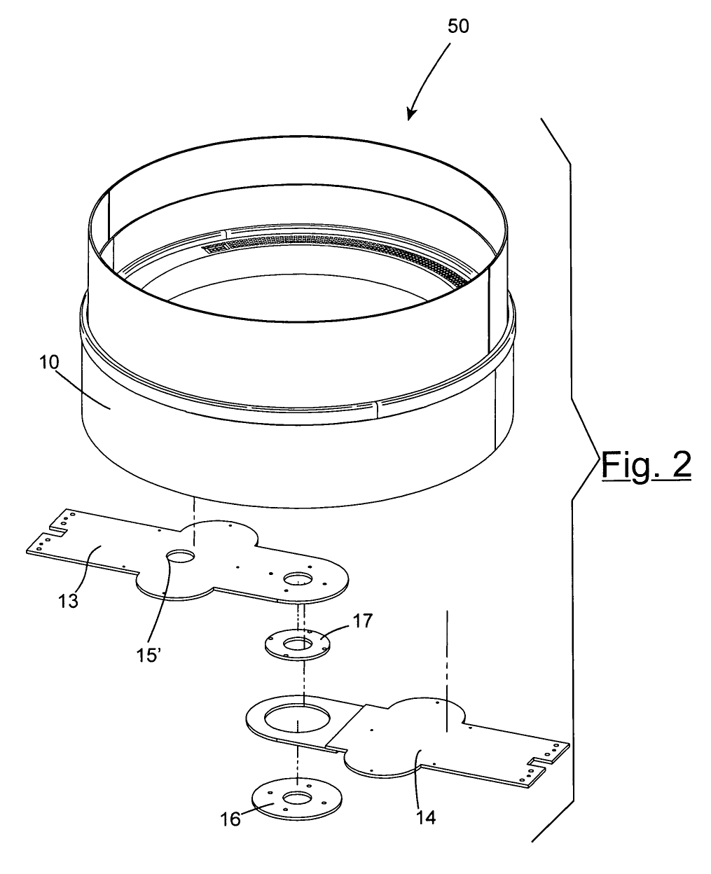

FIG. 2 is an schematic perspective exploded view of an improved joining assembly according to the present invention and shown in the group of FIG. 1; and

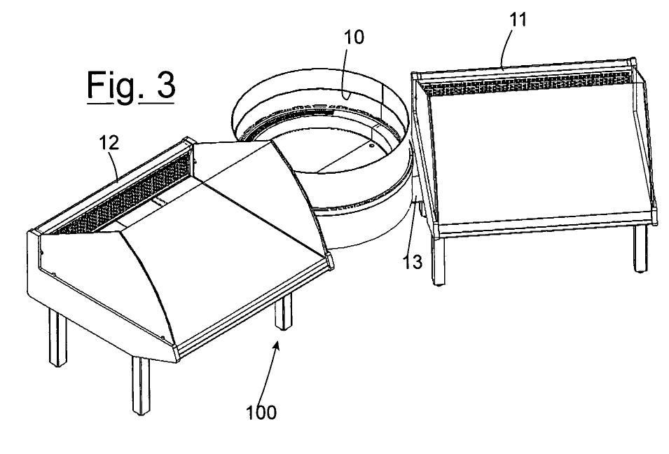

FIG. 3 is a schematic perspective top view of the group of FIG. 1 according to one of the possible angular arrangements.

Referring to the figures, a composite refrigerated exhibition group is indicated by 100 and by 50 an improved joining assembly for refrigerated exhibition counters, according to the present invention.

According to a preferred embodiment shown in FIGS. 1 and 3 the refrigerated exhibition group 100 comprises at least a first and a second refrigerated exhibition counter 11, 12, and at least one coupling element 10 interposed between them.

According to the invention, in such refrigerated exhibition group 100 at least one between the abovementioned first and second refrigerated exhibition counters 11, 12, shown in the example being the second refrigerated exhibition counter 12, is connected at a variable angular position with respect to the coupling element 10.

Thus, in such manner it is possible to attain using such group 100 any angular configuration required and not a single angular configuration fixed positioning the second refrigerated exhibition counter 12 with respect to the coupling element 10 depending on the requirements.

For example a possible angular configuration according to the present invention is shown in FIG. 3 where the abovementioned second refrigerated exhibition counter 12, which rotates around the coupling element 10, can be positioned according to a desired angular position.

According to such preferred embodiment shown in FIG. 1, in order to be positioned according to any angular configuration required, the group 100, comprises a first and a second connection element 13, 14 which couple the coupling element 10 with the refrigerated exhibition counters 11, 12.

In particular, such connection elements 13, 14 are constrained in a stable manner respectively to the first and to the second refrigerated exhibition counters 11, 12 on one side, while on the other side the first connection element 13 is held firm according to a fixed angular configuration against the angular coupling element 10 and the second connection element 14 is constrained at a variable angular position with respect to the same coupling element 10.

It can thus be clearly observed that the second connection element 14, constrained in a stable manner to the second refrigerated exhibition counter 12 on one side, and at a variable angular position with respect to the same coupling element 10 on the other, allows to position the second refrigerated exhibition counter 12 according to any angular configuration required with respect to the coupling element 10, thus providing a refrigerated exhibition group 100 capable of being positioned according to any angular configuration required.

Still according to the embodiment shown in FIG. 1, the abovementioned first and second connection elements 13, 14 extend from a lower central portion of the coupling element 10 until they reach, on the sides of the latter, the related refrigerated exhibition counters 11, 12.

Thus doing, the connection elements 13, 14 at the same time also serve as a support for the coupling element 10, which can thus be kept raised from the ground without the aid of any direct support on the ground beneath.

In order to optimise also the space occupied by the coupling element 10 as exhibition space according to the invention it is provided for that the latter be a exhibition counter, and/or, depending on the requirements a refrigerated exhibition counter.

Still according to the preferred embodiment shown in FIG. 1, the coupling element 10 has a circular-geometry and the first and the second connection elements 13, 14 are two elements provided with two thin rods.

In particular, the first and the second connection elements 13, 14 are pivoted in a rotating manner at the central of the lower circular coupling element 10 through two articulate coupling elements 16, 17, as a fifth wheel coupling, on one side, and on the other side they are fixed in a stable manner, for example by means of screws, to the respective first and second refrigerated exhibition counter 11, 12.

The first connection element 13 is preferably, as mentioned beforehand, constrained at a fixed position against the coupling element 10.

Such constraint derives from the fact that the first connection element 13 has at least one first hole 15′ which is provided at a second hole 15 made in the lower surface of the circular coupling element 10 and from the fact that pipes, conveying a cooling liquid for example, are passed through said overlapped holes 15, 15′.

On the contrary, the second connection element 14 is moveable according to any desired angular position rotating around the abovementioned central pin.

Lastly, according to the invention, it is provided for that the group 100 comprises removable locking means used for constraining the second connection element 14 with respect to the coupling element 10 according to any desired angular position.

In such case, in order to position the group 100 according to another desired angular position, all that shall be required is simple removal of the abovementioned locking means, which are removable as aforementioned, and position the same group 100 according to any another angular position by rotating the second refrigerated exhibition counter 12 around the coupling element 10.

The improved joining assembly 50 for refrigerated exhibition counters 11, 12 which allows positioning the latter according to any angular position is schematically shown exploded in FIG. 2.

Such improved joining assembly 50 according to the present invention comprises the coupling element 10 and the two connection elements 13, 14 as described beforehand.

In particular, they extend starting from a first end constrained to the coupling element 10 towards the external of the same with a second end constrainable in a stable manner against the abovementioned refrigerated exhibition counters 11, 12.

According to the invention, preferably the first connection element 13 is constrainable at a fixed position while the second connection element 14 is constrainable at a variable angular position with respect to the coupling element 10.

As mentioned beforehand, the coupling element 10 can be an exhibition counter and/or a refrigerated exhibition counter.

Lastly, according to the invention, provided for is another embodiment, not shown, in which the refrigerated exhibition group comprising only one between the first and the second refrigerated exhibition counter 11, 12 is connected to the coupling element 10.

In such case, the abovementioned connected refrigerated exhibition counter, for example the second one 12, shall be constrained to the coupling element 10 at a variable angular position while a possibly additional counter, for example the first one 11, shall only be arranged adjacent to the coupling element 10 according to the desired angle and possibly fixed in position.

It is quite easy to understand the operation of the device subject of the finding.

The composite refrigerated exhibition group according to the present invention can be configured angularly according to any angular position required without implying replacement of any component.

Such possibility is conferred to the abovementioned composite refrigerated exhibition group by the improved joining assembly also subject of the present invention and easily associable to the refrigerated exhibition counters.

In particular, this assembly allows forming, using the refrigerated exhibition counters associated to it, a composite refrigerated exhibition group capable of being angularly positioned according to any angular configuration required.

It has thus been observed that a composite refrigerated exhibition group and an improved joining assembly for refrigerated exhibition counters according to the present invention attains the objectives outlined beforehand.

The composite refrigerated exhibition group and the improved joining assembly for refrigerated exhibition counters according to the present invention thus conceived is susceptible to various modifications and variants, all falling within the same invention concept; furthermore, all the details can be replaced by other technically equivalent elements. In practice, the material used, alongside their dimensions, may vary depending of the technical requirements.

1. Composite refrigerated exhibition group (100) comprising at least a first and a second refrigerated exhibition counter (11, 12) and a coupling element (10) interposed between them (11, 12), characterised in that at least one between said first and second refrigerated exhibition counter (11, 12) is connected at a variable angular position with respect to said coupling element (10).

2. Group (100) according to claim 1 characterised in that it further comprises a first and a second connection element (13, 14) constrained in a stable manner respectively to said first and second refrigerated exhibition counter (11, 12) on one side and on the other said first connection element (13) is constrained in a stable manner to said angular coupling element (10) and said second connection element (14) is constrained at a variable angular position with respect to said coupling element (10).

3. Group (100) according to claim 2 characterised in that said first and second connection elements (13, 14) extend from a lower central portion of said coupling element (10) up to said first and second refrigerated exhibition counter (11, 12) and serve as a support for said connection element (10) raised from the ground.

4. Group (100) according to claim 1 characterised in that said coupling element (10) is an exhibition counter.

5. Group (100) according to claim 4 characterised in that said coupling element (10) is a refrigerated exhibition counter.

6. Group (100) according to claim 1 characterised in that said coupling element (10) has a circular-geometry and that said first and second connection elements (13, 14) are two rod-shaped elements provided which are pivoted in a rotating manner to the centre of lower surface of said circular coupling element (10) through two articulated coupling elements (16, 17) on one side and fixed in a stable manner to said first and second refrigerated exhibition counter (11, 12) on the other side, wherein said first connection element (13) is constrained at a fixed position with respect to said circular coupling element (10) and said second connection element (14) is moveable according to any desired angular position with respect to the coupling element(10).

7. Group (100) according to claim 6 characterised in that said first connection element (13) is constrained at a fixed position with respect to said coupling element (10) through the coupling of a first hole (15′) of said first connection element (13) with a second hole (15) of said coupling element (10), wherein pipes are passed through said holes (15, 15′).

8. Group (100) according to claim 6 characterised in that it comprises removable fixing means for constraining said second connection element (14) with respect to said coupling element (10) according to any desired angular position.

9. Improved joining assembly (50) for refrigerated exhibition counters (11, 12) comprising a coupling element (10), a first and a second connection element (13, 14) which extend starting from a first end constrained to said coupling element (10) towards the external of the same with a second end constrainable in a stable manner against said refrigerated exhibition counters (11, 12), wherein said first connection element (13) is constrained at a fixed position with respect to said coupling element (10) and said second connection element (14) is constrained at a variable angular position with respect to said coupling element (10).

10. Assembly (50) according to claim 9 characterised in that said coupling element (10) is an exhibition counter.

11. Assembly (50) according to claim 10 characterised in that said coupling element (10) is a refrigerated exhibition counter.

12. Assembly (50) according to claim 9 characterised in that said coupling element (10) has a circular-geometry and that said first and second connection elements (13, 14) are two rod-shaped elements pivoted in a rotating manner to the centre of the lower surface of said circular coupling element (10) through two articulated coupling elements (16, 17) on one side and fixed in a stable manner to said first and second refrigerated exhibition counters (11, 12) on the other, wherein said first connection element (13) is constrained at a fixed position with respect to said circular coupling element (10) and said second connection element (14) is moveable according to any desired angular position with respect to the coupling element (10).

13. Composite refrigerated exhibition group comprising a first and a second refrigerated exhibition counter (11, 12) and a coupling element (10) wherein one between said first and second refrigerated exhibition counter (11, 12) is connected to a side of said coupling element (10) at a variable angular position with respect to said coupling element (10), another one of said first and second refrigerated exhibition counter (11, 12) being arranged adjacent to another side of said coupling element (10).
